(19) United States
(12) Patent Application Publication
(10) Pub. No.: US 2012/0200089 A1
(43) Pub. Date: Aug. 9, 2012

(54) UNIT FOR A HYDROELECTRIC POWER PLANT AND MODULAR HYDROELECTRIC POWER PLANT COMPRISING SAID UNIT

(76) Inventors: Luca Deandrea, Casalborgone (IT); Marina Porraro, La Loggia (IT); Massimo Baewert, Torino (IT)

(21) Appl. No.: 13/387,666

(22) PCT Filed: Jul. 19, 2010
(86) PCT No.: PCT/IB2010/053278

§ 371 Date: Apr. 20, 2012

(30) Foreign Application Priority Data
Jul. 30, 2009 (IT) TO2009A000592

(51) Int. Cl. F03B 13/10; F03G 7/04

(52) U.S. Cl. 290/54; 60/398

(57) ABSTRACT

The present invention refers to a underwater unit (1) for a hydroelectric power plant and a modular hydroelectric power plant (2) comprising a plurality of such units. The unit (1) according to the invention uses the principle of functioning of the traditional hydroelectric power plants and comprises a penstock (200) which involves a “head” of at least 100 m, and preferably of about 150-300 m, and carries elevated kinetic energy water masses from the surface of a water basin down to one or more turbines (301a-301f) provided in depth under the surface of the basin itself, so as to transfer the kinetic energy from the water to said turbines and to transform then the kinetic energy into electric power. Thanks to the use of variable volume discharge tanks (313a,313b) positioned downstream the turbines, it is possible to easily and effectively return the water masses used for the actuation of turbines themselves to the surrounding environment.

### TECHNICAL FIELD

The present invention refers to a unit for a hydroelectric power plant. More in particular, the present invention refers to an underwater unit for a hydroelectric power plant.

The present invention refers also to an underwater hydroelectric power plant comprising at least one such unit.

### PRIOR ART

Hydroelectric power plants are widely spread and used for the production of electric power.

These plants use flowing water masses for the production of electric power: water is conveyed into one or more turbines which rotate thanks to the thrust of the water; each turbine is coupled to an alternator which transforms the rotational movement into electric power. The speed given by the water to the turbines is generated through a height difference of at least 100 m and preferably of about 150-300 m, called “head”, which is converted into hydrodynamic pressure at the height at which the turbines are positioned.

In order to have a reserve of water sufficient for the operation of the hydroelectric power plant, generally an artificial basin is created by means of the barrage of a river gorge with a dam: from this basin the water is conveyed through the “head” in a penstock down to the turbines, to the blades of which it transfers the kinetic energy.

Although hydroelectric power plants can have undoubted advantages with respect to thermoelectric or nuclear-thermoelectric power plants, they are not free from drawbacks.

Firstly, the requirement of a height difference between the basin and the turbines limits the choice of the possible sites for the installation of the plants. Secondly, the need for the creation of an artificial basin strongly affects the construction costs of the plant. Thirdly, the dams blocking the river gorges, block the solid transport of the rivers (sands and gravels) down to the sea where, because of the reduced or null solid deposit, there is the phenomenon of coast erosion. Finally, large hydroelectric basins can have environmental and socio-economic impacts of strong entity or gravity on the surrounding areas owing to the modification of the landscape and to the destruction of natural habitats, to the population movements, to the loss of agricultural areas and so on.

In order to solve the problems related to the need for the availability of large water masses and for a height difference between the water basin and the turbines, the realization of underwater hydroelectric power plants, wherein a penstock carries the water from the surface to the turbines positioned in depth has been considered.

The setting of hydroelectric power plants on the bed of the sea, of big lakes or of similar water basins having large dimensions eliminates the need of creating artificial basins and makes available nearly unlimited water resources for the plant.

Examples of underwater hydroelectric power plants of the kind described above are shown by way of example in UA23002U and in IT1117257.

However, the setting of a hydroelectric power plant realized in this way in the depths of a natural water basin poses the problem of the disposal of the water flowing from the turbines, because the large water masses used must be transferred from the hydroelectric power plant—which is at the same pressure as the inlet port of the penstock, and thus substantially at atmospheric pressure—to the surrounding environment, which is at a much higher pressure.

The main object of the present invention is to solve the aforesaid problem, by providing an underwater unit of hydroelectric power plant able to easily and effectively dispose the water masses flowing from the turbines.

Another object of the present invention is to provide an underwater hydroelectric power plant able to generate an electric power comparable to the one of conventional hydroelectric power plants.

### DISCLOSURE OF THE INVENTION

Thanks to the presence of a penstock comprising an inlet section and an outlet section, said outlet section being provided at least at 100 m depth and preferably at about 150-300 m depth with respect to said inlet section, it is possible to provide the “head” which ensures to the water entering the unit according to the invention a sufficient speed for the operation of the turbine(s).

Preferably, said inlet section of said penstock is positioned close to the surface of the water basin.

Furthermore, thanks to the presence of at least a variable volume discharge tank positioned downstream the turbines for the generation of the electric power, the unit for the production of electric power according to the invention permits to effectively discharge in the surrounding environment the water masses used for the operation of the turbines themselves.

In a preferred embodiment there are provided at least two variable volume tanks which are alternatively filled and emptied, so that it is possible to ensure the continuous operation of the unit according to the invention.

Preferably, said variable volume tanks are expansion tanks.

It is to be noticed at this regard that US 2008/0159855 describes an underwater hydroelectric power plant comprising variable volume discharge tanks.

However, the hydroelectric power plant described in this document has remarkable drawbacks. Firstly, it does not provide any penstock and the inlet port for the water is positioned immediately over the turbine, so that the water entering the turbine does not have an elevated speed, because no “head” is provided and enormous low-speed water volumes are required for the operation of the described plant. Secondly, this plant employs, for the emptying of the discharge tanks, a complex compressed-air system, which generates a huge increase in production costs, linked to the need of providing air under very high pressure at elevated depths under the level of the surface of the water basin. Finally, owing to the fact that the inlet port of the plant is in depth, thus under elevated pressure, it is probably necessary to provide an expensive pressurization system for keeping the environment of the turbine under the atmospheric pressure.

Advantageously, the unit for a hydroelectric power plant according to the invention is free from all these drawbacks.

A plurality of units according to the invention can be associated together for creating a modular hydroelectric power plant.

The modularity of the plant for the production of electric power thus obtained permits the continuous operation of the electric power plant according to the invention, even in case of breakdown, malfunctioning, maintenance and/or replacement of single units.

### BRIEF DESCRIPTION OF THE DRAWINGS

Other advantages and features of the invention will be evident from the following detailed description of a preferred embodiment of the invention, given by way of non-limiting example, with reference to the attached drawings, wherein:

FIG. 1 is a schematic representation of the unit for the hydroelectric power plant according to the invention;

FIG. 2 is a schematic sectional front view of the room which houses the turbines of the unit of FIG. 1;

FIG. 3 is a schematic sectional lateral view of the room of FIG. 2;

FIG. 4 is a section along the line IV-IV of the room of FIG. 2;

FIG. 5 is a schematic representation of the hydroelectric power plant according to the invention.

### DESCRIPTION OF A PREFERRED EMBODIMENT

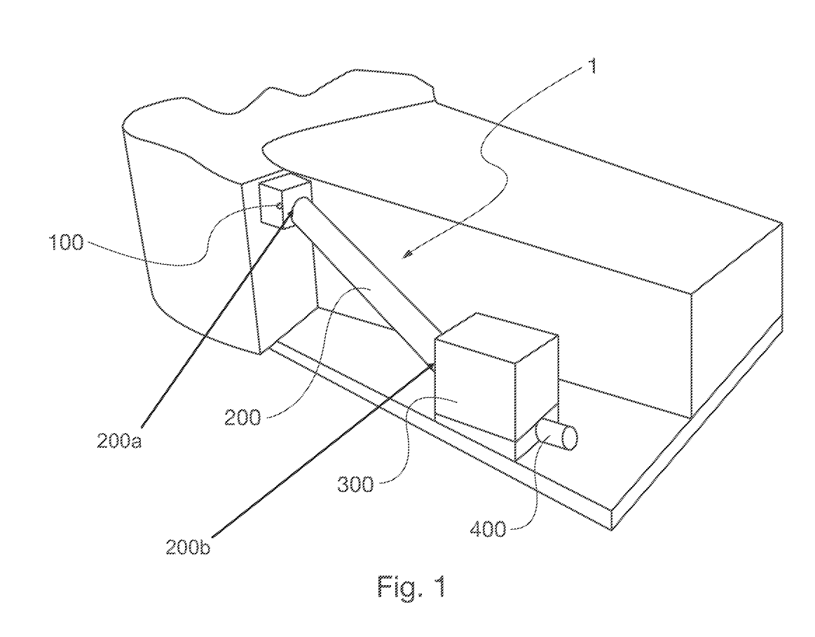

With reference to FIG. 1, the underwater unit 1 of the hydroelectric power plant according to the invention is designed for being positioned in a water basin of any kind, either natural (sea, lake, and so on) or artificial. Said underwater unit 1 generally comprises:
an inlet port 100 for the water which is used for the production of the electric power, said inlet port 100 being substantially provided at the surface of the water basin;
an outlet port 400 for allowing the water used for the production of the electric power to return to the water basin, said outlet port 400 being provided in depth in said water basin;
a piping arrangement which connects said inlet port with said outlet port, said piping arrangement including a penstock 200 which comprises an inlet section 200a and an outlet section 200b, the outlet section 200b of said penstock being at a depth greater than 100 m and preferably equal to 150-300 m with respect to said inlet section 200a of said penstock 200, so as to descend in depth in the water basin and thus to provide the “head” which permits to give the kinetic energy to the water; said penstock 200 is preferably inclined, so as to avoid cavitation problems inside the penstock itself;
one or more turbines, preferably housed in a room 300, positioned along said piping arrangement, between said inlet port 100 and said outlet port 400, downstream said penstock 200 so that the kinetic energy of the water mass which flows in said penstock is transferred to said turbines; in room 300 are equally housed the alternators associated to said turbines for the transformation of the kinetic energy into electric power.

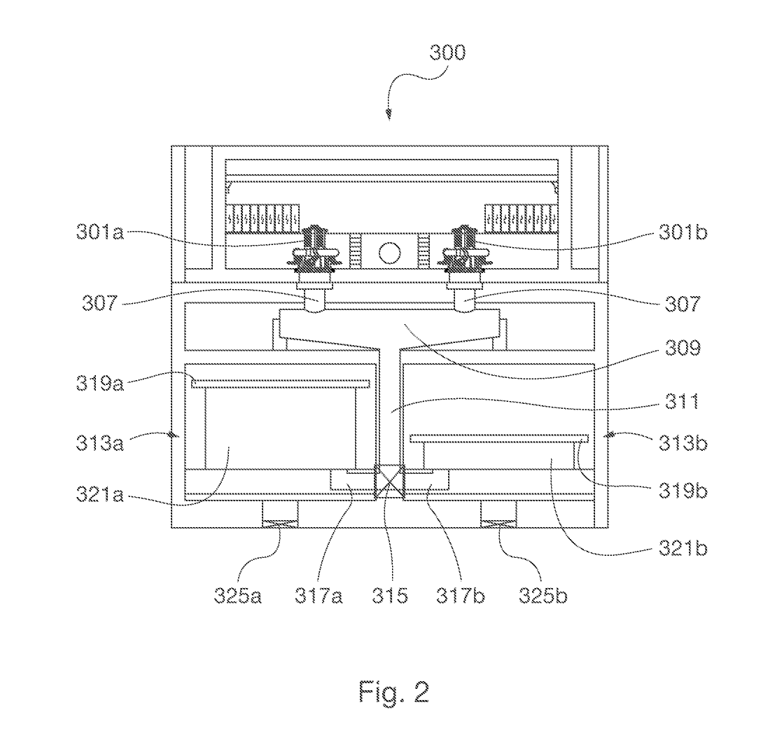

Said room 300 within which the kinetic energy is transmitted from the water mass flowing from the penstock to the turbines and successively transformed into electric power is shown more in detail in FIGS. 2-4.

The room 300 is watertight with respect to the external environment, so that the pressure inside it is equal to the pressure at the inlet port of unit 1, that is substantially equal to the atmospheric pressure.

Room 300 houses one or more turbines 301a-301f (six in the shown form of embodiment) which are arranged in such a way as to intercept the water flowing from the penstock 200, thanks to an extension 303 of the penstock itself which enters the room 300 and is divided in branches 305, each one connected with a respective turbine 301a-301f, so that the kinetic energy is transferred from the water to the blades of said turbines.

The turbines 301a-301f are preferably Pelton turbines, which are particular suitable for working in applications with high differences in height and reduced water flow rates; however, also turbines of other kind can be used.

The shaft of each turbine 301a-301f is connected in a known way with a corresponding alternator (not shown) which permits to transform the kinetic energy of the blades of said turbines into electric power.

According to the invention, the water used for the operation of the turbines 301a-301f is conveyed, through corresponding outlet channels 307, in a common transit chamber 309. Said common chamber is connected, through a duct 311, with at least a variable volume tank.

In particular, in the shown embodiment, two variable volume tanks 313a,313b are provided: the duct 311 is divided in two branches 317a,317b, each one connected with a corresponding variable volume tank 313a,313b; a three-way selecting valve 315 is provided at the bifurcation of the duct 311, so that the water flowing from the transit chamber 309 can be selectively addressed towards the one or the other tanks 313a,313b.

Said variable volume tanks 313a,313b are preferably realized as expansion tanks, even if it is possible to provide any other kind of variable volume tanks.

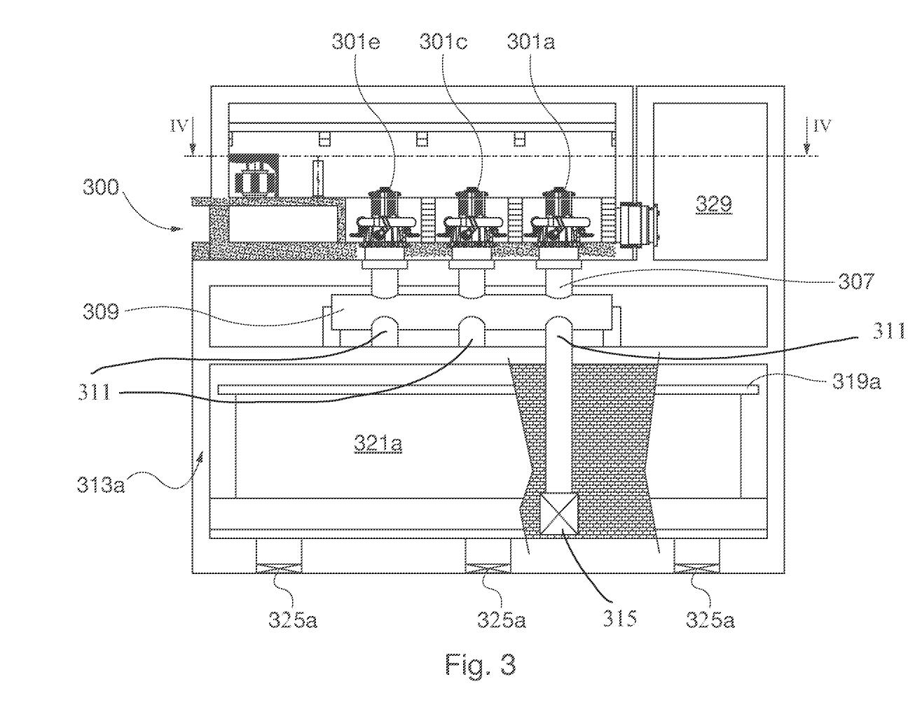

With reference in particular to FIGS. 2 and 3, each tank 313a,313b comprises a variable volume compensation chamber 321a,321b, separated from the rest of the tank by a movable wall 319a,319b.

Each tank is provided with a hydraulic driving system comprising one or more cylinders which operate on the movable wall 319a,319b of the respective compensation chamber 321a,321b for moving it away from or close to the base of the tank itself.

Each of the branches 317a,317b of duct 311 communicates with the compensation chamber 321a,321b of the respective tank, so that when the selecting valve 315 puts into communication the duct 311 with the branch 317a (317b respectively), the water enters said compensation chamber 321a (321b respectively) of the tank 313a (313b respectively), causing a volume increase. In this filling phase the cylinders of the hydraulic system work for moving the movable wall 319a (319b respectively) away from the base of the tank, increasing the capacity of the compensation chamber.

The compensation chambers 321a,321b of tanks 313a,313b are also connected with the outlet port 400 of unit 1 according to the invention by means of one or more valves 325a,325b, for example non-return valves.

In this way, once the compensation chamber of a tank has reached the maximum possible expansion, it can be put in communication with the outlet port 400 and, through it, with the surrounding environment, so that the water contained in said tank can be discharged to the outside.

In this emptying phase, the cylinders of the hydraulic system operate for moving the movable wall close to the base of the tank, reducing the capacity of the compensation chamber.

Obviously, before opening the valve 325a,325b of communication with the outlet port 400, the communication between the tank 313a,313b and the duct 311 is interrupted by operating opportunely on the selecting valve 315.

It is evident that only one variable volume tank would be sufficient for ensuring a correct operation of unit 1 according to the invention. However, in case of only one tank, the operation of unit 1 should be interrupted each time it is necessary to empty of said tank.

On the other hand, it will be evident to the person skilled in the art that the presence of two tanks 313a,313b which are alternatively put in communication with the duct 311, so as to be alternatively filled and emptied, ensures the continuous operation of unit 1 according to the invention: when the selecting valve 315 puts in communication the duct 311 with the first tank 313a, its compensation chamber 321a can be progressively filled; in this phase, the second tank 313b is in communication with the outlet port 400 through the valves 325b and is emptied; when the compensation chamber of the first tank reaches the maximum expansion, the selecting valve 315 is switched for putting in communication the duct 311 with the second tank 313b for the transfer of water inside it, whereas the valves 325b of the first tank 313a are opened for allowing the water contained inside it to return into the surrounding environment.

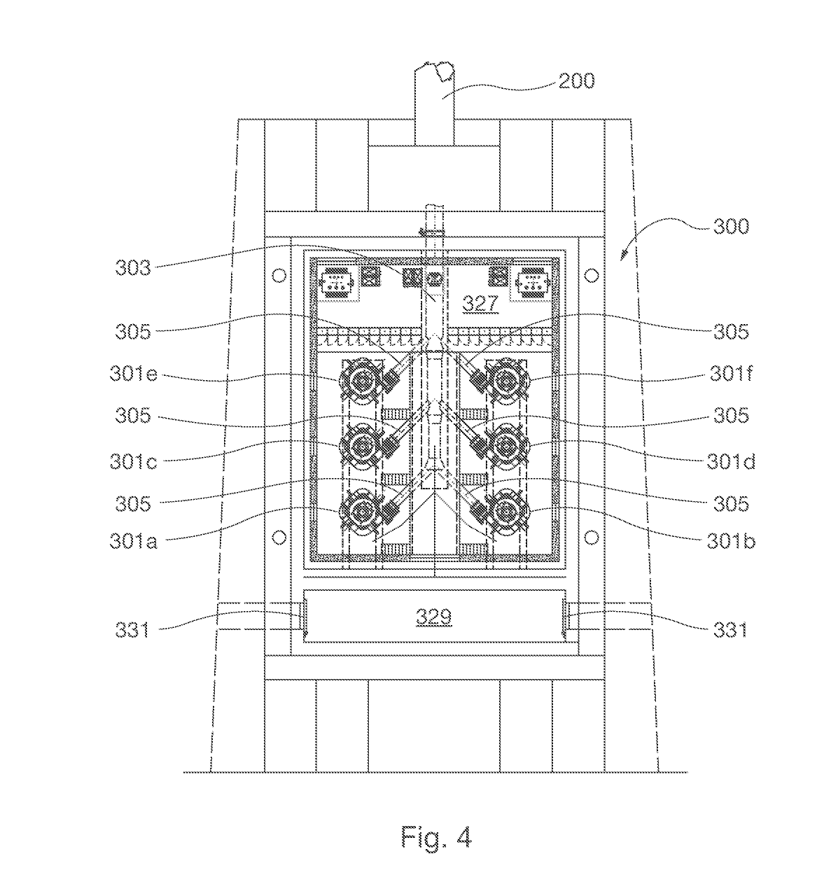

With reference to FIG. 4, it is shown how the room 300, besides the room which houses the turbines and their alternators, comprises also another room 327 which houses the management, control and maintenance equipment of the mechanical and electrical equipment of unit 1.

Furthermore, in room 300 there is provided a passageway 329 for entering room 300 for maintenance; obviously, in order to carry out the inspection and the maintenance of unit 1 also when it is operating and is in depth, said passageway is closed at the ends by watertight bulkheads 331.

In the shown preferred embodiment, wherein six turbines 301a-301f are provided, assuming that the room 300 is laid at about 150 meters under the level of the water basin, the unit 1 according to the invention permits to obtain a delivered power of nearly 6000 kW.

The consumptions of electric power necessary to the correct operation of the equipment of said unit—that is to the energetic self-sustaining of the unit—can be estimated around 200-300 kW, that is lower than the 5% of the power produced, whereas the remaining 95% is exploitable for other applications.

According to the invention, in order to obtain a hydroelectric power plant with a power comparable to the one of conventional plants, it is possible to provide for the mutual association of a suitable number of units of the kind described above.

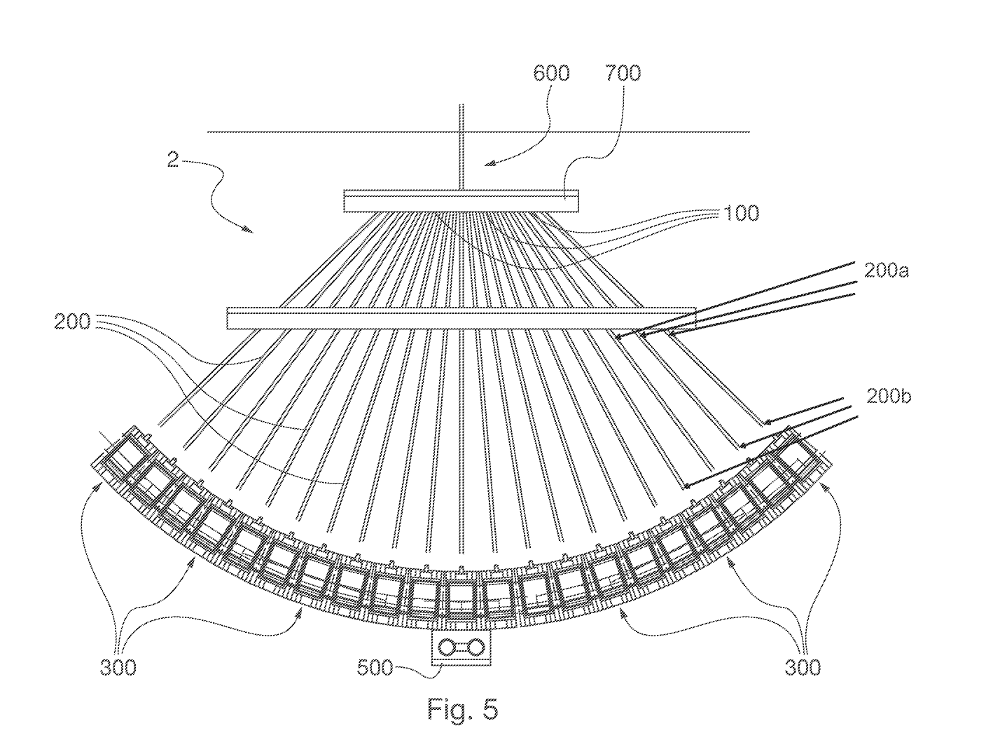

With reference to FIG. 5, an electric power plant 2 so built is schematically shown.

Said electric power plant 2 comprises a feeding conduct 600 for the water of the water basin close to the surface, said conduct ending into a plenum 700 in communication with the inlet ports 100 of the units of the hydroelectric power plant. The penstocks 200 of said units depart from said plenum 700 and each of them ends inside the corresponding room 300 housing the turbines and the alternators for the production of electric power.

Advantageously, the rooms 300 of the different units are arranged side-by-side and in mutual communication thanks to the inspection passageways provided inside each unit.

A device for accessing the surface 500 is provided in communication with one of the units (in particular with the central unit in the illustrated example), so that from the surface the operators can easily access the rooms of all the units for inspection and maintenance operations.

In the example shown, the units are arranged in a spoke-like pattern along an arch of nearly 90° and twenty-one of them are provided, for a total produced power equal to nearly 120 MW.

Obviously, both the arrangement of the units and their number can vary according to the requirements.

For obvious reasons of ease of access and of transfer of the produced electric power towards the dry land, it is preferable to provide the positioning of the electric power plant close to the coast (for example, in correspondence of disused harbors), which limits the extension of the arch formed by the units arranged side-by-side at an angle lower than 180°.

However, it would be also possible to provide an electric power plant according to the invention positioned away from the coast and comprising a number of units sufficient for covering an entire arch of 360°, with a consequent increase of the generated power.

It is evident from the above description that the unit of the hydroelectric power plant according of the invention and the modular hydroelectric power plant formed by the juxtaposition of a plurality of such units permit to reach the objects set forth above, because they permit to obtain electric power by using the nearly unlimited water resources of large natural water basins and to easily, effectively and economically return the used water to said basins.

It is also evident that the embodiment described above has been provided by way of non-limiting example and that many variants are possible without departing from the scope of protection as defined by the appended claims.

1. Unit for a hydroelectric power plant, suitable to be placed underwater in a water basin, comprising
an inlet port for feeding the water of the water basin to the unit;
an outlet port for discharging the water of the water basin from the unit, the outlet port being provided at a depth greater than the inlet port;
a piping arrangement which connects the inlet port to the outlet port, the piping arrangement comprising a penstock;
one or more turbines provided along the piping arrangement, downstream the penstock, arranged so as to intercept the water flowing therethrough, each of the turbines being associated to a corresponding alternator;
characterized in that wherein the penstock comprises an inlet section and an outlet section, the outlet section being at least at 100 meters of depth with respect to the inlet section, so that the water which flows through the penstock acquires a corresponding kinetic energy and in that in the piping arrangement, between the turbines and the outlet port one or more variable volume discharge tanks (313a,313b) are provided.

2. Unit according to claim 1, wherein the variable volume discharge tanks are expansion tanks comprising a variable volume compensation chamber.

3. Unit according to claim 1, wherein two variable volume discharge tanks are provided.

4. Unit according to claim 3, wherein the piping arrangement is provided with a selecting valve, arranged between the turbines and the variable volume discharge tanks for selectively connecting one of the two tanks with the piping arrangement.

5. Unit according to claim 1, wherein a plurality of turbines are provided, the piping arrangement providing a plurality of branches provided between the penstock and the turbines so as to connect the piping arrangement with each of the turbines.

6. Unit according to claim 5, wherein downstream each of the turbines the piping arrangement provides a water outlet channel, the outlet channels being connected to a common transit chamber, connected to the variable volume tank(s).

7. Unit according to claim 1, wherein the one or more turbines as well as the corresponding alternators are housed in a watertight room.

8. Unit according to claim 7, wherein the room includes a passageway for entering the room itself, the passageway being provided at its ends with watertight bulkheads.

9. Unit according to claim 1, in wherein the inlet port is provided close to the surface of the water basin.

10. Unit according to claim 9, wherein the inlet section of the penstock is provided close to the surface of the water basin.

11. Unit according to claim 1, wherein the outlet section of the penstock is at a depth with respect to the inlet section of the penstock equal to nearly 150-300 m.

12. Plant for electric power production comprising a plurality of units for electric power production according to claim 1.
